(19) United States
(12) Patent Application Publication
(10) Pub. No.: US 2013/0214197 A1
(43) Pub. Date: Aug. 22, 2013

(54) ENCAPSULATED CROSS-LINKED PIGMENT DISPERSIONS

(71) Applicant: Harry Joseph Spinelli, Wilmington, DE (US)

(72) Inventor: Harry Joseph Spinelli, Wilmington, DE (US)

(73) Assignee: EI DU PONT DE NEMOURS AND COMPANY, Wilmington, DE (US)

(21) Appl. No.: 13/882,338

(22) PCT Filed: Dec. 15, 2011
(86) PCT No.: PCT/US11/65139

§ 371 Date: Apr. 29, 2013

Related U.S. Application Data
(60) Provisional application No. 61/423,244, filed on Dec. 15, 2010.

(51) Int. Cl. C09D 151/00; C09D 5/23

(52) U.S. Cl. CPC C09D 151/003; C09D 5/23
USPC 252/62.54; 524/413

(57) ABSTRACT

The present disclosure provides pigment dispersions containing a dispersant, and a pigment coated by a polymer that is cross-linked with a crosslinker. The polymer swells in an application medium resulting in improved, stability for the pigment dispersions.

### CROSS REFERENCE TO RELATED APPLICATIONS

This application claims priority under 35 U.S.C. §119 from U.S. Provisional Application Ser. No. 61/423,244, filed Dec. 15, 2010, which is incorporated by reference in its entirety.

### BACKGROUND OF THE DISCLOSURE

This disclosure relates to novel pigment dispersions containing a pigment coated by a polymer that is cross-linked with a crosslinker. The polymer swells in an application medium resulting in improved stability. Also disclosed is the use of these dispersions in ink-jet inks.

Dispersions of pigment particles are widely used in ink-jet printing. Because a pigment is typically not soluble in an aqueous vehicle, a dispersing agent is often required, such as a polymeric dispersant or a surfactant, to produce a stable dispersion of the pigment in the aqueous vehicle. However, because the pigment is dispersed in a liquid vehicle, there is a tendency for pigment particles to agglomerate and settle while an ink is being stored or while an ink is being used, for example, being printed. For pigment particles with high density, such as titanium dioxide, it is common for the pigment particles to settle during storage.

There has been effort in the art directed at improving the stability of pigment dispersions. The effort to improve dispersion stability to date has included, improvements in the processes used to make the dispersions, the development of new dispersants and the exploration of the interaction between dispersants and pigment particles, and between dispersants and aqueous vehicle. While much of the effort has general application at improving dispersion stability, some of that effort has not found utility in particular demanding end use applications, such as the production of ink-jet inks and automotive paints. For example, the pigment dispersions used, in ink-jet printing applications have very unique requirements. It is critical that ink components comprising pigment dispersion remain stable, not only in storage but also over repeated jetting cycles. Similarly, the pigment dispersions in paints are required, to be non-settling or with only minimum amount of settling during storage and have high re-dispersability.

A need exists for highly stable, non-settling pigment dispersions to be used in ink-jet inks and paints. The present disclosure satisfies this need by providing a pigment dispersion containing a pigment coated by a polymer that is cross-linked with a crosslinker. The polymer swells in an application medium resulting in enhanced, stability and improved printing performance.

### SUMMARY OF THE DISCLOSURE

An embodiment of the disclosure provides a pigment dispersion comprising: a dispersant, and a polymer-coated pigment comprising a polymer and a pigment particle in a dispersion medium, wherein the ratio of the pigment particle to the polymer is between 10:1 and 1:10; wherein the polymer is cross-linked with a crosslinker and the polymer swells in an application medium that utilizes the pigment dispersion; and wherein the dispersion medium and the application medium independently contain water, solvent, or mixtures thereof.

Another embodiment provides that the polymer-coated pigment has an average particle diameter of at least 200 nm.

Another embodiment provides that the polymer swell at least 10 nm in the application medium.

Another embodiment provides that the density of the pigment particle is greater than 2.0 g cm⁻³.

Another embodiment provides that the polymer is a pre-formed polymer.

Another embodiment provides that the polymer is formed by polymerization of one or more monomers adsorbed, onto the surface of the pigment particle.

Another embodiment provides that the ratio of the pigment particle to the polymer is between 5:1 and 1:10.

Another embodiment provides that the ratio of the pigment particle to the polymer is between 2:1 and 1:10.

Another embodiment provides that the dispersant is an acrylic resin.

Another embodiment provides that the dispersant is a graft polymer.

Another embodiment provides that the polymer is formed by polymerization of one or more monomers selected from the group consisting of acrylates, methacrylates, vinyl ethers, styrenes and maleic anhydrides.

Another embodiment provides that the polymer is formed by polymerization of one or more monomers containing crosslinkers selected, from the group consisting of ethyleneglycol dimethacrylate, diethyleneglycol dimethacrylate, triethyleneglycol dimethacrylate, tetraethyleneglycol dimethacrylate, polyethyleneglycol dimethacrylate, ethyleneglycol diacrylate, diethyleneglycol diacrylate, triethyleneglycol diacrylate, tetraethyleneglycol diacrylate, polyethyleneglycol diacrylate, trimethylol propane trimethacrylate, trimethylol propane triacrylate, divinylbenzene, propyleneglycol dimethacrylate, dipropyleneglycol dimethacrylate, propyleneglycol diacrylate and dipropyleneglycol diacrylate.

Another embodiment provides that the pigment particle comprises titanium dioxide.

Another embodiment provides that the pigment particle comprises a magnetic component.

Another embodiment provides that the dispersion medium is water.

Another embodiment provides that the application medium is solvent.

Another embodiment provides that the dispersion medium is water with a pH of greater than 8.

Another embodiment provides that the dispersion medium is water with a pH of less than 6.

Another embodiment provides that the application medium is water with a difference of greater than 3 in pH compared to the pH of the water in the dispersion medium.

Another embodiment provides an ink-jet ink comprising a pigment dispersion comprising: a dispersant, and a polymer-coated pigment comprising a polymer and a pigment particle in a dispersion medium, wherein the ratio of the pigment particle to the polymer is between 10:1 and 1:10; wherein the polymer is cross-linked with a crosslinker and the polymer swells in an application medium that utilizes the pigment dispersion; and wherein the dispersion medium and the application medium independently contain water, solvent, or mixtures thereof.

Another embodiment provides an ink-jet ink consisting of an ink vehicle and a pigment dispersion comprising: a dispersant, and a polymer-coated pigment comprising a polymer and a pigment particle in a dispersion medium, wherein the ratio of the pigment particle to the polymer is between 10:1 and 1:10; wherein the polymer is cross-linked with a crosslinker and the polymer swells in an application medium that utilizes the pigment dispersion; and wherein the dispersion medium and the application medium independently contain water, solvent, or mixtures thereof.

Yet another embodiment provides a paint comprising a pigment dispersion comprising: a dispersant, and a polymer-coated pigment comprising a polymer and a pigment particle in a dispersion medium, wherein the ratio of the pigment particle to the polymer is between 10:1 and 1:10: wherein the polymer is cross-linked with a crosslinker and the polymer swells in an application medium that utilizes the pigment dispersion; and wherein the dispersion medium and the application medium independently contain water, solvent, or mixtures thereof.

These and other features and advantages of the present embodiments will be more readily understood by those of ordinary skill in the art from a reading of the following Detailed Description. Certain features of the disclosed embodiments which are, for clarity, described above and below as a separate embodiment, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used, herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed, from any pair of any upper range limit or preferred value and any lower range limit or preferred value, regardless of whether ranges are separately disclosed. Where a range of numerical values is recited herein, unless otherwise stated, the range is intended to include the endpoints thereof, and ail integers and fractions within the range.

When the term “about” is used in describing a value or an end-point of a range, the disclosure should be understood to include the specific value or end-point referred to.

As used, herein, the dispersions produced with the polymer described above can be utilized to disperse particles, especially pigments for ink-jet inks. These inks can be printed on all normally used ink-jet substrates including textile substrates.

As used herein, the term “dispersion” means a two phase system where one phase consists of finely divided particles (often in the colloidal size range) distributed throughout a bulk substance, of the particles being the dispersed or internal phase and the bulk substance being the continuous or external phase.

As used, herein, the term “dispersant” means a surface active agent added to a suspending medium to promote uniform and maximum separation of extremely fine solid particles often of colloidal size. For pigments, dispersants are most often polymeric dispersants.

As used herein, the term “aqueous vehicle” refers to water or a mixture of water and at least one water-soluble, or partially water-soluble (i.e. methyl ethyl ketone), organic solvent (co-solvent).

As used herein, the term “substantially” means being of considerable degree, almost all.

As used herein, the term “MW” means weight average molecular weight.

As used herein, the term “Mn” means number average molecular weight.

As used herein, the term “D50” means the volume particle diameter of the 50th percentile (median) of the distribution of particle sizes.

As used herein, the term ‘D95’ means the volume particle diameter of the 95th percentile of the distribution of particle sizes.

As used herein, the tem “ionizable groups,” means potentially ionic groups.

As used herein, the term “NCO” means isocyanate.

As used herein, the term “cPs” means centipoise, a viscosity unit.

As used herein, the term “encapsulation” means covering pigment particles with a layer of materials in an amount greater than what is needed to disperse the pigment particles. The terms “coating” and “encapsulating” may be used interchangeably.

As used herein, the term “crosslinker” means monomers with 2 or more polymerizable groups or functional groups on a monomer that has polymerized that are capable of further reacting among themselves or with a reagent. In the case of crosslinking a pre-formed polymer, the crosslinker is an externally added crosslinking agent.

As used herein, the term “RAFT” means radical addition fragmentation technology.

As used, herein, the term “mN·m⁻¹” means milliNewtons per meter, a surface tension unit.

As used herein, the term “mPa·s” means millipascal second, a viscosity unit.

As used herein, the term “AN” means acid, number, mg KOH/gram of solid, polymer.

As used herein, the term “MEK” means methyl ethyl ketone.

As used herein, the term “DBTDL” means dibutyltin dilaurate.

As used, herein, the term “TBA” means tributyl amine.

As used, herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid.

As used herein, the term “NTA” means nitrilotriacetic acid.

As used, herein, the term “DHEG” means dihydroxyethylglycine.

As used herein, the term “CyDTA” means trans-1,2-cyclohexanediaminetetraacetic acid.

As used herein, the term “DTPA” means diethylenetriamine-N,N,N′,N″,N″-pentaacetic acid.

As used herein, the term “GEDTA” means glycoletherdiamine-N,N,N′,N′-tetraacetic acid.

As used herein, Vazo® 52, Vazo® 67 and Vazo® 68 mean different formulations of 2,2′-azobis(2,4-dimethylvaleronitrile), catalysts supplied by DuPont, Wilmington, Del.

As used herein, the term “Sulfolane” means tetramethylene sulfone.

Unless otherwise noted, the above chemicals were obtained from Aldrich (Milwaukee, Wis.) or other similar suppliers of laboratory chemicals.

In addition, references in the singular may also include the plural (for example, “a” and “an” may refer to one, or one or more) unless the context specifically states otherwise.

Within the context of this disclosure, the term “neutralizing agents” is meant to embrace all types of agents which are useful for converting potentially ionic or ionizable groups to ionic groups.

### Dispersant

A wide variety of dispersants can be used in the present disclosure. Suitable dispersants include polymeric dispersants such as acrylic, styrenic, polyurethane, and polyester, etc. The dispersant can be an anionic, cationic, or non-ionic stabilizing species. Both ionic and steric forms of stabilization can be employed. The dispersant can be designed to be used in an aqueous system or in a solvent based system. In an aqueous system, the dispersant can be used at low pH as well as at high pH depending on the specific design. The dispersant can also be a surfactant, such as sodium dodecyl sulfonate and nonylphenol polyethylene oxide.

The polymeric dispersant used to stabilize the pigment particle is typically either a structured polymer or a random polymer. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched or graft structure. Examples of structured polymers include AB or BAB block copolymers as disclosed in U.S. Pat. No. 5,085,698; ABC block copolymers as disclosed in EP-A-G556649; and graft copolymers. The graft copolymers typically have a weight average molecular weight of from about 4,000 to about 100,000, and more typically from about 10,000 to about 40,000. Mixtures of more than one graft copolymer can also be used. The graft copolymer comprises from about 90% to about 50% by weight of a polymeric backbone and, correspondingly, from about 10% to about 50% by weight of polymeric side chains (arms) attached to the backbone. Typically, the polymeric backbone is a hydrophobic (relative to the side chains) adsorbing segment, and the side chains contain hydrophilic stabilizing macromonomers from the polymerization of ethylenically unsaturated “hydrophilic” monomers, such as ethylenically unsaturated monomers containing an acid group or a nonionic hydrophilic group. Alternatively, the polymeric backbone can be hydrophilic and the side chains hydrophobic. The side chains are attached to the backbone at a single terminal point. For a leading reference on graft copolymers, see: U.S. Pat. No. 5,231,131.

The polymeric dispersant suitable for use in the present disclosure generally comprise both hydrophobic and hydrophilic monomers. Some examples of hydrophobic monomers used in random polymers are methyl methacrylate, n-butyl methacrylate, 2-ethylhexyl methacrylate, benzyl methacrylate, 2-phenylethyl methacrylate and the corresponding acrylates. Some examples of hydrophilic monomers are methacrylic acid, acrylic acid, dimethylaminoethyl(meth)acrylate, and salts thereof.

Other polymeric dispersants that can be used are described, for example, in U.S. Pat. Nos. 6,117,921; 6,262,152; 6,306,994 and 6,433,117.

### Pigment

A wide variety of organic and inorganic pigments, alone or in combination, may be dispersed with the polymer described above to prepare an ink, especially an ink-jet ink. The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment. The pigment used in the present disclosure does not include self-dispersed pigments. The pigment particles are sufficiently small to permit free flow of the ink through the ink-jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from settling. It is also desirable to use small particles for maximum color strength and gloss. The range of useful pigment particle size is typically about 0.2 micron to about 15 micron. Typically, the pigment particle size should range from about 0.2 to about 5 micron and, most typically, from about 0.2 to about 1 micron. The average particle size of the pigment particles as measured by dynamic light scattering is less than about 500 nm, typically less than about 300 nm.

Pigments of high density are particularly suitable for this disclosure. Typically, the pigment has a density of greater than 1.5 g cm⁻³. More typically, the pigment has a density of greater than 2 g cm⁻³.

The selected pigments) may be used in dry or wet form. For example, pigments are usually manufactured in aqueous media, and the resulting pigments are obtained, as a water-wet presscake. In presscake form, the pigment does not agglomerate to the extent like it is in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index, Third Edition, 1971.

Titanium dioxide (TiO₂) pigment useful in the present disclosure may be in the rutile or anatase crystalline form. The titanium dioxide particles can have a wide variety of average particle sizes of about 1 micron or less, depending on the desired end use applications.

For applications demanding high hiding or decorative printing applications, the titanium dioxide particles typically have an average size of less than about 1 micron (1000 nanometers). Typically, the particles have an average size of from about 50 to about 950 nanometers, more typically from about 75 to about 750 nanometers, and still more typically from about 100 to about 500 nanometers. These titanium dioxide particles are commonly referred to as pigmentary TiO₂.

For applications demanding white color with some degree of transparency, the pigment preference is “nano” titanium dioxide. “Nano” titanium dioxide particles typically have an average size ranging from about 10 to about 200 nanometers, more typically from about 20 to about 150 nanometers, and most typically from about 35 to about 75 nanometers. An ink comprising nano titanium dioxide can provide improved chroma and transparency, while still retaining good resistance to light fade and appropriate hue angle. A commercially available example of an uncoated nano titanium oxide is P-25, available from Evonik (Parsippany, NT).

The titanium dioxide is typically incorporated into an ink formulation via a slurry concentrate composition. The amount of titanium dioxide present in the slurry composition is typically from about 15% to about 80%, by weight based on the total slurry weight.

The titanium dioxide pigment may be substantially pure titanium dioxide or may contain other metal oxides, such as silica, alumina and zirconia. Other metal oxides may become incorporated into the pigment particles, for example, by co-oxidizing or co-precipitating titanium compounds with other metal compounds. If co-oxidized or co-precipitated metals are present, they are typically present as the metal oxide in an amount from about 0.1% to about 20%, and more typically from about 0.5% to about 5%, by weight based on the total titanium dioxide pigment weight.

The titanium dioxide pigment may also bear one or more metal oxide surface coatings. These coatings may be applied, using techniques known by those skilled in the art. Examples of metal oxide coatings include silica, alumina, alumina-silica and zirconia, among others. Such coatings may optionally be present in an amount of from about 0.1% to about 10%, and typically from about 0.5% to about 3%, by weight based on the total weight of the titanium dioxide pigment. Commercial examples of such coated titanium dioxides include R700 (alumina-coated, available from E.I. DuPont de Nemours and Company, Wilmington, Del.), RDI-S (alumina-coated, available from Kemira Industrial Chemicals, Helsinki. Finland), R-706 (available from DuPont, Wilmington, Del.) and W-6042 (a silica alumina treated nano grade titanium dioxide from Tayco Corporation, Osaka, Japan).

The titanium dioxide pigment may also bear one or more organic surface coatings, such as, for example, carboxylic acids, silanes, siloxanes and hydrocarbon waxes, and their reaction products with the titanium dioxide surface. The amount of organic surface coating, when present, generally ranges from about 0.01% to about 6%, typically from about 0.1% to about 3%, and more typically about 0.5% to about 1.5%, by weight based on the total weight of the pigment.

The pigment may include a magnetic component for making a magnetic ink with character recognition property. Typical magnetic components include, but are not limited to, iron oxides and mixtures thereof, such as, for example, FeO, Fe₂O₃, and magnetite (FeO.Fe₂O₃). The magnetic components can exist in any arrangement including octahedral, spherical and acicular forms. Typical commercially available magnetites include, but are not limited, to, Magnox B353 (available from Magnox Inc., Wilmington, Del.) and Mapico Black (available from Mapico Inc., LeMay, Mo.).

In the case of organic pigments, the ink may contain up to approximately 30%, typically from 0.1% to about 25%, and more specifically from 0.25% to 10% of pigment, by weight based on the total ink weight. If an inorganic pigment is selected, the ink will tend to contain higher percentages by weight of pigment than with comparable inks employing organic pigment, since inorganic pigments generally have higher densities than organic pigments.

### Dispersion Medium

A dispersion medium is a medium where the pigment dispersions of the present disclosure are prepared. Typically, the dispersion medium is water. The dispersion medium can also be a solvent or a mixture of water and solvent.

### Application Medium

Application medium is a medium where the pigment dispersions of the present disclosure are utilized. Typically, the application medium is a solvent. The application medium can also be water, provided that it has a difference in pH of greater than 3 compared to that of the dispersion medium if the dispersion medium is also water.

### Preparation of Encapsulated Cross-Linked Pigment Dispersion

The encapsulated cross-linked pigment dispersions of the present disclosure can be prepared by the following steps:

### Step 1: Preparation of an Initial Pigment Dispersion

The initial pigment dispersions used in this embodiment can be prepared using any conventional milling process known in the art. Suitable processes include media mill, high speed dispersers, microfluidizer, ball mills, and roll mills, etc. Most milling processes use a two-step process involving a first mixing step followed by a second grinding step. The first step comprises mixing of all the ingredients, that is, pigment, dispersants, liquid carriers, neutralizing agent and any optional additives to provide a blended “premix”. Typically all liquid ingredients are added first, followed by the dispersants, and lastly the pigment. Mixing is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 120 minutes.

The second step comprises grinding of the premix to produce a pigment dispersion. Typically, grinding involves a media milling process, although other milling techniques can also be used. In the present disclosure, a lab-scale Eiger Minimill (Model M250, VSE EXP) manufactured by Eiger Machinery Inc., Chicago, Ill. is employed. Grinding was accomplished by charging about 820 grams of 0.5 YTZ® zirconia media to the mill. The mill disk is operated at a speed between 2000 rpm and 4000 rpm, and typically between 3000 rpm and 3500 rpm. The dispersion is processed using a re-circulation grinding process with a typical flow rate through the mill at between 200 to 500 grams/minute, and more typically at 300 grams/minute. The milling may be done using a staged procedure in which a fraction of the solvent or water is held out of the grind and added after milling is completed. This is done to achieve optimal rheology that maximizes grinding efficiency. The amount of solvent or water held out during milling varies by dispersion, and is typically between 200 to 400 grams for a batch size with a total of 800 grams. Typically, the dispersions of the present embodiment are subjected to a total of 4 hours of milling.

For black dispersions, an alternate milling process using a Microfluidizer can be used. Microfluidization is a non-media milling process in which milling is done by pigment impingement through nozzles under high pressures. Typically, pigment dispersions are processed at 15,000 psi with a flow rate of 400 grams/minute for a total of 12 passes through the mill.

Step 2: Polymerization of Monomers and, Crosslinking

A polymerization process is employed to introduce polymer onto the pigment surface. Monomers are fumed into small droplets and distributed onto the pigment surface typically under sonication condition. The monomers then polymerize to form a polymer coating the pigment surface. Suitable monomers include vinyl based monomers such as acrylates, methacrylates, vinyl ethers, styrenes, maleic anhydrides, etc. The polymerization process may include free radical processes using initiators such as Vazo® and peroxide initiators. The polymerization process can also include using redox types of initiations and approaches such as radical addition fragmentation technology (RAFT), group transfer polymerization and anionic polymerization, etc.

The amount of the monomers is such to result in a ratio of pigment particles to polymers from the polymerization of monomers in a range from 10:1 to 1:10. Typically this ratio of pigment particles to polymers is from 5:1 to 1:10. More typically, this ratio of pigment particles to polymers is from 2:1 to 10:1.

The monomers may also include crosslinkers, i.e., functional groups that can be cross-linked to form a polymer network. Crosslinking is achieved by copolymerizing one or more polyfunctional monomers or by post-reacting functional groups on the polymer. Suitable polyfunctional monomers containing crosslinkers include monomers such as ethyleneglycol dimethacrylate, diethyleneglycol dimethacrylate, triethyleneglycol dimethacrylate, tetraethyleneglycol dimethacrylate, polyethyleneglycol dimethacrylate, ethyleneglycol diacrylate, diethyleneglycol diacrylate, triethyleneglycol diacrylate, tetraethyleneglycol diacrylate, polyethyleneglycol diacrylate, trimethylol propane trimethacrylate, trimethylol propane triacrylate, divinylbenzene, propyleneglycol dimethacrylate, dipropyleneglycol dimethacrylate, propyleneglycol diacrylate, and dipropyleneglycol diacrylate, etc.

The amount of crosslinker typically ranges from 0.05% to 20%, by weight based on the total weight of the monomers. More typically the amount of crosslinker ranges from 0.1% to 10%, by weight based on the total weight of the monomers. Even more typically, the amount of crosslinker ranges from 0.25% to 2%, by weight based on the total weight of the monomers.

Alternatively, the encapsulated cross-linked pigment dispersion of the present disclosure can be prepared, by the following steps:

### Step 1A: Preparation of a Pre-Formed Polymer

A pre-formed polymer is prepared prior to the preparation of the pigment dispersion. Suitable pre-formed polymer includes vinyl polymer such as methacrylate, acrylates, styrenes, and maleic anhydrides, etc., as well as copolymers from methacrylate, acrylates, styrenes, and maleic anhydrides. Suitable pre-formed polymer also includes condensation polymers, such as polyurethanes, polyesters, and polyamides, etc. The pre-formed polymer may be a random, block, graft, branched or star polymer.

Polyurethanes are, for the purpose of the present disclosure, polymers where the polymer backbone contains urethane linkage derived from the reaction of an isocyanate group (from, e.g., a di- or higher-functional monomeric, oligomeric or polymeric polyisocyanate) with a hydroxyl group (from, e.g., a di- or higher-functional monomeric, oligomeric or polymeric polyol). Such polymers may, in addition to the urethane linkage, also contain other isocyanate-derived linkages such as urea, as well as other types of linkages present in the polyisocyanate components or polyol components (such as, for example, ester and ether linkage).

Step 2A: Preparation of an Initial Pigment Dispersion with Pre-Formed Polymer

The pre-formed polymer is added during the dispersion process as described in Step 1 above to deposit it onto the pigment surface. This can also be done using a process where a polar diluent liquid is gradually added during the dispersion treatment.

Alternatively, the pre-formed polymer can be added, after making the initial pigment dispersion to deposit the pre-formed polymer onto the pigment surface. This can also be done in the presence of certain solvent with slight solubility in water, such as MEK.

### Step 3A: Cross-Linking of the Pre-Formed Polymer

The pre-formed polymer typically has cross-linkable moieties that can react with a crosslinker after the pre-formed polymer is adsorbed onto the pigment surface. The cross-linkable moieties, upon reacting with a crosslinker, provide a cross-linked pigment dispersion. Typical parings of cross-linkable moiety and crosslinker are listed in the table below.

| Cross-linkable Moieties | Crosslinker |
|---|---|
| COOH, SO₃H | Epoxide, Carbodiimide, Oxazoline, N-Methyol |
| Hydroxyl | Epoxide, Silane, Isocyanate, N-Methyol |
| Amino | Epoxide, Carbodiimide, Oxazoline, N-Methyol |

The mole ratio of the cross-linkable moiety on the pre-formed polymer to the crosslinker is from 15:1 to 1:15, typically from 9:1 to 1:1.1, and more typically from 8:1 to 1:1. In calculating the mole ratio, all cross-linkable moieties on the pre-formed polymer and all cross-linking group on the crosslinkers are included.

In the cross-linking step, a crosslinker is mixed with the initial pigmented dispersions prepared above in Step 2A at room temperature or elevated temperature for a period from 2 h to 8 h. To facilitate the cross-linking reaction, it may be desirable to add a catalyst. Useful catalysts can be those that are either soluble or insoluble in the liquid and can be selected depending upon the crosslinking reactions. Some suitable catalysts include dibutyltin dilaurate (DBTDL), tributyl amine (“TBA”) and dimethyldodecyl amine,

### Preparation of Swollen Pigment Dispersions

The cross-linked polymer encapsulating pigment particles in the initial pigment dispersions prepared in Step 2 and Step 3A above swells when the dispersions are inverted from water to a solvent or by the addition of an effective amount of a solvent. The inversion, or utilizing the pigment dispersion in an application medium, may be accomplished by subjecting the encapsulated and cross-linked pigment dispersion to a drying process followed by addition of a solvent. Both spray drying and tray drying in an oven can be employed. The effective amount of solvent is the amount needed to cause an encapsulated cross-linked pigment dispersion to swell at least 10 nm in diameter.

The crosslinked polymer encapsulated pigment dispersion can also be inverted within the water medium by changing the pH of the dispersion. In this situation, water serves as both the dispersion medium and the application medium. For example, adjusting the pH from 3.0 to 8.0 by adding an appropriate base (amine, and alkali metal hydroxides, etc.) or adjusting the pH from 8.0 to 3.0 by adding an appropriate acid, (hydrochloric, nitric acid, sulfuric acid, or organic acids) can cause the dispersion to swell.

Fillers, plasticizers, pigments, carbon black, silica sols, other polymer dispersions and the known leveling agents, wetting agents, antifoaming agents, stabilizers, and other additives known for the desired end use, may also be incorporated into the dispersions.

### Ink Vehicle

The pigmented ink of this disclosure comprises an ink vehicle typically an aqueous or a solvent ink vehicle, also known as a carrier medium, and optionally other ingredients.

The ink vehicle is the liquid carrier (or medium) for the aqueous or solvent dispersion and optional additives. The term “aqueous ink vehicle” refers to an ink vehicle comprised of water or a mixture of water and one or more organic, water-soluble vehicle components commonly referred to as co-solvents or humectants. The term “solvent ink vehicle” refers to an ink vehicle comprised of one or more organic solvents or oils. Selection of a suitable mixture depends on requirements of the specific application, such as desired surface tension and viscosity, the selected pigment, drying time of the pigmented ink-jet ink, and the type of paper onto which the ink will be printed. Sometimes in the art, when a co-solvent can assist in the penetration and drying of an ink on a printed substrate, it is referred to as a penetrant.

Examples of water-soluble organic solvents and humectants include: alcohols, ketones, keto-alcohols, ethers and others, such as thiodiglycol, Sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

A mixture of water and a polyhydric alcohol, such as diethylene glycol, is typical as the aqueous ink vehicle. In the case of a mixture of water and diethylene glycol, the ink vehicle usually contains from 30% water and 70% diethylene glycol to 95% water and 5% diethylene glycol, more typically from 60% water and 40% diethylene glycol to 95% water and 5% diethylene glycol. Percentages are based on the total weight of the ink vehicle. A mixture of water and butyl carbitol is also an effective ink vehicle.

The amount of ink vehicle in the ink is typically in the range of from 70% to 99.8%, and more typically from 80% to 99.8%, by weight based on total weight of the ink.

The ink vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. Typical 1,2-alkanediols are C₄-C₆ alkanediols with 1,2-hexanediol being most typical. Suitable surfactants include ethoxylated acetylene diols (e.g. Surfynol® series commercially available from Air Products), ethoxylated alkyl primary alcohols (e.g. Neodol® series commercially available from Shell) and secondary alcohols (e.g. Tergitol® series commercially available from Union Carbide), sulfosuccinates (e.g. Aerosol® series commercially available from Cytec), organosilicones (e.g. Siiwet® series commercially available from Witco) and fluoro surfactants (e.g. Zonyl® series commercially available from DuPont).

The amount of glycol ether(s) and 1,2-alkanediol(s) added is typically in the range of from 1% to 15%, and more typically from 2% to 10%, by weight based on the total weight of the ink. Surfactants may be used, typically in the amount of from 0.01% to 5% and more typically from 0.2% to 2%, by weight based on the total weight of the ink.

### Additives

Other ingredients, additives, may be formulated into the inkjet ink, to the extent that such other ingredients do not interfere with the stability and jetability of the inkjet ink. This may be readily determined by routine experimentation by one skilled in the art.

Surfactants are commonly added to inks to adjust surface tension and wetting properties. Suitable surfactants include the ones disclosed in the “Vehicle” section above. Surfactants are typically used in amounts up to about 5% and more typically in amounts up to 2%, by weight based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or non-ionic. Soluble polymers include linear homopolymers and copolymers or block polymers. They can also be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. The polymers may be made by a solution, emulsion, or suspension polymerization process. Preferred classes of polymer additives include anionic acrylic, styrene-acrylic and polyurethane polymer.

When a polymer is present, the polymer level is typically between about 0.01% and about 3%, by weight based on the total weight of an ink. The upper limit is dictated by ink viscosity or other physical limitations.

Biocides may be used to inhibit growth of microorganisms.

Pigmented ink-jet inks typically have a surface tension in the range of about 20 mN·m⁻¹ to about 70 mN·m⁻¹, at 25° C. Viscosity can be as high as 30 mPa·s at 25° C., but is typically somewhat lower. The ink has physical properties compatible with a wide range of ejecting conditions, materials construction and the shape and size of the nozzle. The inks should have excellent storage stability for long periods so as not to clog to a significant extent in an ink-jet apparatus. Further, the ink should not corrode parts of the ink-jet printing device it comes in contact with, and it should be essentially odorless and non-toxic.

Although not restricted to any particular viscosity range or printhead, the inks of the present disclosure are particularly suited to lower viscosity applications. Thus the viscosity (at 25° C.) of the inks of this disclosure may be less than about 7 mPa·s, or less than about 5 mPa·s, and even more advantageously, less than about 3.5 mPa·s.

The following examples illustrate specific embodiments of the present disclosure without, however, being limited thereto.

### Examples

### Particle Size Measurements

The particle size for the polyurethane dispersions, pigments and the inks were determined by dynamic light scattering using a Microtrac® UPA 150 analyzer from Honeywell/Mierotrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to derive the particle size distribution. Results are reported as D50 or D95.

### Polymer Dispersant 1

The following is an example of how to make a block polymer with a composition of BZMA//MAA 13//10.

To a 12-liter flask equipped with a mechanical stirrer, a thermometer, a nitrogen inlet, a drying tube outlet and three addition funnels under a nitrogen atmosphere were added tetrahydrofuran (THF, 3750 g) and p-xylene (7.4 g). To the flask was added catalyst tetrabutyl ammonium m-chlorobenzoate (1.0 M solution in acetonitrile, 3.0 ml), followed by an initiator, 1,1-bis(trimethylsiloxy)-2-methyl propene (291.1 g, 1.25 moles). Another portion of the catalyst tetrabutyl ammonium m-chlorobenzoate (1.0 M solution in acetonitrile, 3.0 ml) was added via one of the additional funnels (Feed I) over a period of 180 minutes. At the same time when Feed I was started, trimethylsilyl methacrylate (1975 g, 12.5 moles) was added via another additional funnel (Feed II) over a period of 35 minutes. One hundred minutes after Feed II was completed (over 99% of the monomers had reacted), benzyl methacrylate (2860 g, 16.3 moles) was added via the third additional funnel (Feed III) over a period of 30 minutes. At 400 minutes from the start of Feed I, methanol (800.0 g) was added, to the above mixture and a distillation was initiated. During the first stage of the distillation, 2,500.0 g of materials was removed. To the remaining mixture was added 2-pyrrolidone (3,000.0 g), and an additional 2255.0 g of materials was removed by distillation. Additional 2-pyrrolidone (2,250 g) was added resulting in a polymer with 41.5% of solids.

This polymer had a composition of BZMA//MAA 13//10 with a number average molecular weight (Mn) of 3,200 and an acid value of 3.52. About 90% of the acid contents in this polymer were subsequently neutralized with aqueous KOH followed by inverting the polymer into water to give Polymer Dispersant 1 with 15% of solids.

### Polymer Dispersant 2

The following is an example of how to make a graft polymer with a comb-like structure with a molecular configuration of: nBA/MA/AA/MAA(29.62/29.62/5.86/0.52)-g-MMA/MAA(24.49/9.89)

In the above representation, the polymer backbone (nBA/MA/AA/MAA) makes up 65% of the polymer, where nBA is n-butyl acrylate, MA is methyl acrylate, AA is acrylic acid, and MAA is mathacrylic acid. The notation (29.62/29.62/5.86/0.52) indicates the relative percents of each monomer. The arms, comprised of a macromonomer (g-MMA/MAA), make up the remaining 35% of the total polymer, where MMA is methyl methacrylate and MAA is methacrylic acid, present in amounts of 24.49% and 9.89%, respectively. In this representation, a “-g-” represents a graft polymer made from a macromonomer with the macromonomer composition following the “-g-”, and a single slash indicates a random copolymer within the segment.

### Preparation of Macromonomer 1

This example illustrates the preparation of a macromonomer that was used to form a graft copolymer.

To a 12-liter flask equipped with a thermometer, a stirrer, additional funnels, a heating mantle, a reflux condenser and a means of maintaining a nitrogen atmosphere over the reactants were added a solution of methacrylic acid (237 g), methyl methacrylate (586.9 g), and isopropanol (840.0 g) in acetone (1,240.0 g). The resulting mixture was heated and maintained at reflux temperature for about 20 minutes. To the mixture was added a second solution of diaquabis(borondifluorodiphenyl glyoximato)cobaltate (II) (Co(DPG-BF₂), 0.552 g) and Vazo® 52 (4.32 g) in acetone (172.0 g). To the reaction mixture were added simultaneously a third solution containing methacrylic acid (711.2 g) and methyl methacrylate (1760.8 g), and a fourth solution containing diaquabis(borondifluorodiphenyl glyoximato)cobaltate (II), (Co(DPG-BF₂), 1.10 g) and Vazo® 52 (52.0 g) in acetone (1,028.0 g) over a period of 3 hours and 15 minutes while maintaining the reaction mixture at reflux temperature of about 72° C. The reaction mixture was refluxed for another hour to give a clear, thin solution of Macromonomer 1 with a solid content of about 51%. This macropolymer contained methyl methacrylate and methacrylic acid and had a weight average molecular weight of 1,340 and a number average molecular weight of 1,090 as measured by Gel Permeation Chromatography (GPC).

Macromonomer 1 was then polymerized, with other monomers to make the target graft polymer.

To a 2-liter flask equipped with a mechanical stirrer, a thermometer, a nitrogen inlet, a drying tube outlet, and addition funnels under a nitrogen atmosphere were added Macromonomer 1 (369.95 g), n-butyl acrylate (19.51 g), acrylic acid (3.86 g), methyl acrylate (19.51 g) and isopropanol (23.27 g). The reaction mixture was heated to reflux temperature. To the mixture was added a shot of iso-propanol (1.69 g) and t-butyl hydroperoxide (0.20 g), and heating was continued for another 10 minutes. To the mixture was added another shot of iso-propanol (1.69 g) and t-butyl hydroperoxide (0.20 g), and heating was continued for another 20 minutes. To the mixture was then added a solution of n-butyl acrylate (143.07 g), acrylic acid (28.29 g) and methyl acrylate (143.05 g) in isopropanol (9.05 g) over a period of 180 minutes while maintaining the reaction mixture at reflux temperature. Another solution containing isopropanol (41.29 g), methyl ethyl ketone (10.65 g) and methacrylic acid (2.86 g) was added at the same time when the last solution was added, but over a period of 240 minutes. The reaction mixture was heated at reflux for an additional 90 minutes. This generated a graft polymer with a composition of nBA/MA/AA/MAA(29.62/29.62/5.86/0.52)-g-MMA/MAA(24.49/9.89) having 62.5% of solids.

The resin was neutralized with dimethylethanol amine and inverted into water to give Polymer Dispersant 2 with 30% of solids.

### Polymer Dispersant 3

The following is an example of how to make a triblock polymer with a composition of DMAEMA//BZMA//MAA 10//6.5//10.

To a 3-liter flask equipped with a mechanical stirrer, a thermometer, a nitrogen inlet, a drying tube outlet and addition funnels under a nitrogen atmosphere were added tetrahydrofuran (THF, 800 g) and p-xylene (7.4 g). To the flask was added catalyst tetrabutyl ammonium m-chlorobenzoate (1.0 M solution in acetonitrile, 0.5 ml), followed by an initiator, 1,1-bis(trimethylsiloxy)-2-methyl propene (50.0 g, 0.216 moles). Another portion of the catalyst tetrabutyl ammonium m-chlorobenzoate (1.0 M solution in acetonitrile, 0.5 ml) was via one of the additional funnels (Feed I) over a period of 180 minutes. At the same time when Feed I was started, trimethylsilyl methacrylate (341 g, 2.16 moles) was added via another additional funnel (Feed II) over a period of 35 minutes. One hundred minutes after Feed II was completed (over 99% of the monomers had reacted), benzyl methacrylate (247 g, 1.40 moles) was added via the third additional funnel (Feed III) over a period of 30 minutes. Thirty minutes after Feed III was completed (over 99% of the monomers had reacted), dimethylaminoethyl methacrylate (338.0 g, 2.15 moles) was added via Feed IV over 30 minutes. At 500 minutes from the start of Feed I, methanol (150.0 g) was added to the above mixture and a distillation was initiated. During the first stage of the distillation, 450.0 g of materials was removed. To the remaining mixture was added 2-pyrrolidone (600.0 g), and an additional 500.0 g of materials was removed by distillation. An additional amount of 2-pyrrolidone (550 g) was added resulting in a polymer with 37.8% of solids.

This polymer had a composition of MAA//BZMA//DMAEMA 10//6.5//10 with a number average molecular weight (Mn) of 3,600 and an acid value of 3.01. About 90% of the amines in this polymer were subsequently neutralized with nitric acid followed, by inverting the polymer into water to give Polymer Dispersant 3 with 15% of solids.

### Pigment Dispersion 1

To a high speed disperse (HSD) were charged, water (1,813 g) and Polymer Dispersant 2 (1,167 g). Mixing was conducted at slow speed for 15 minutes before titanium dioxide pigment (RDIS from Kimera Chemicals, 7000 g) was added. The speed of the HSD was increased and maintained at 3,000 rpm for 4 hours. To the mixture was then added Proxel GXL (Arch Chemicals, 20.00 g) to give a white TiO₂ dispersion, Pigment Dispersion 1, with 70% of pigment solids.

### Pigment Dispersion 2

This shows the preparation of a white pigment dispersion containing 20% of white pigment with polymer around, the pigment formed by the polymerization of a monomer containing 4% of a crosslinker. The pigment to monomer (P/M) ratio was 4 to 1, which gave a pigment dispersion that contained 5% of polymerized polymer.

Pigment Dispersion 1 (114.29 g) and Polymer Dispersant 1 (53.33 g) were mixed with water (188.77 g). To the mixture was added a solution containing butyl methacrylate (20.00 g) and ethyleneglycol dimethacrylate (0.80 g). The resulting mixture was sonicated at 30% Amplitude using an intermittent sonication process of sonicating for 2 seconds followed, by idling for 4 seconds for a total of 15 minutes. The sonicated mixture was added to a 500 milliliter flask equipped with a thermometer, a stirrer, additional funnels, a heating mantle, a reflux condenser and a means of maintaining a nitrogen blanket over the reactants. The reaction mixture was heated to 72° C. To the reaction mixture was added a solution of Vazo® 52 (0.56 g) and aqueous potassium hydroxide (10% solution, 2.25 g) in water (20 g). The resulting mixture was maintained at 72° C. for three hours to give Pigment Dispersion 2 containing 20% of pigment with 5% of polymer (a pigment/polymer ratio of 4/1) encapsulating the pigment.

### Pigment Dispersions 3-11

Dispersions 3-11 were prepared by a procedure similar to the preparation of Dispersion 2 using different amounts of monomers and crosslinkers. The compositions of Dispersions 2-11 including the ratio of pigment to monomer polymerized (P/M) and the percent (based on monomers polymerized) of crosslinker utilized in the polymerization/crosslinking process are shown in Table 1 below.

TABLE 1

| Pigment | | |
|---|---|---|
| Dispersion No. | P/M | % Crosslinker |
| 2 | 4 | 4 |
| 3 | 2 | 8 |
| 4 | 2 | 4 |
| 5 | 2 | 2 |
| 6 | 2 | 1 |
| 7 | 2 | 0.5 |
| 8 | 2 | 0.25 |
| 9 | 1 | 4 |
| 10 | 1 | 1 |
| 11 | 1 | 0.5 |

### Pigment Dispersion 12

Pigment Dispersion 12 was prepared by drying a 500 gram sample of Dispersion 2 to the extent of having greater than 98% of solids, followed, by adding 400 grams of methyl ethyl ketone (MEK) and passing the resulting mixture twice through a media mill to give a solvent based, dispersion with 20% of solids.

This prepared a stable dispersion in MEK solvent. It is thought that the stability of the dispersion is a result of the presence of the polymer from the polymerization of monomers. This polymer provides steric stabilization via its loops and tails.

### Pigment Dispersions 13-21

Pigment Dispersions 13-21 were prepared by a procedure similar to the preparation of Dispersion 12 using different starting dispersions. The compositions of Dispersions 12-21 including the starting dispersion, the ratio of pigment to monomer polymerized (P/M) and the percent (based on monomers polymerized) of crosslinker utilized, in the polymerization/crosslinking process for making the starting dispersions are shown in Table 2 below.

TABLE 2

| Pigment | Starting | | |
|---|---|---|---|
| Dispersion No. | Dispersion No. | P/M | % Crosslinker |
| 12 | 2 | 4 | 4 |
| 13 | 3 | 2 | 8 |
| 14 | 4 | 2 | 4 |
| 15 | 5 | 2 | 2 |
| 16 | 6 | 2 | 1 |
| 17 | 7 | 2 | 0.5 |
| 18 | 8 | 2 | 0.25 |
| 19 | 9 | 1 | 4 |
| 20 | 10 | 1 | 1 |
| 21 | 11 | 1 | 0.5 |

### Control Polymer 1

The following describes the preparation of an emulsion having the same polymeric composition as the ones formed from the polymerization of monomers in Dispersions 2-21, but without a pigment present.

To a 2 liter beaker were added Polymer Dispersant 1 (15% solids, 213.32 g) and water (471.76 g). To this mixture was added a solution containing butyl methacrylate (320.0 g) and ethyleneglycol dimethacrylate (12.8 g). The resulting mixture was sonicated at 30% Amplitude using an intermittent sonication process of sonicating for 2 seconds followed by idling for 4 seconds for a total of 15 minutes. The sonicated mixture was then added to a 2 liter flask equipped with a thermometer, a stirrer, additional funnels, a heating mantle, a reflux condenser and a means of maintaining a nitrogen blanket over the reaction mixture. The contents in the flask were heated to 72° C. To the flask was added a solution of Vazo® 68 (9.00 g), aqueous potassium hydroxide (10% solution, 35.96 g) in water (80 g). The resulting mixture was maintained at 72° C. for three hours to give Control Polymer 1 containing 32.7% of solids.

### Control Pigment Dispersion 1

This control example shows how to prepare a pigment dispersion without a layer of polymer that has been cross-linked, and swollen coating the pigment particle.

To a high speed, disperser (HSD) were charged Polymer Dispersant 2 (1,167 g) and water (1,813 g). This was mixed at slow speed for 15 minutes. To the mixture was added slowly titanium dioxide pigment (RDIS from Kimera Chemicals, 7,000 g), and the speed of the HSD was increased to 3,000 rpm. Mixing was continued for 4 hours at the speed of 3,000 rpm. To the resulting mixture was added Proxel GXL (Arch Chemicals, 20 g) to give a white TiO₂ dispersion with 70% of solids.

### Testing of Non-Settling Property

The dispersions were tested to determine the rate of settling of the titanium dioxide pigment over time. A test was run to determine the amounts of TiO₂ in an ink before and after aging for 3 or more days. A small sample of the ink was diluted 1,000 times with an appropriate solvent and the absorbance at 500 nm was measured. Another small sample of the same TiO₂ ink was placed in a 40 ml test tube and allowed, to sit for 3 or more days. Without disturbing the test tube, the top 10 ml of ink was removed and subsequently diluted 1,000 times, and its absorbance at 500 nm was measured the same way as for the initial ink sample. The percent of pigment not settled during the aging period was obtained from the ratio of the initial absorbance over the absorbance after aging. A higher value of non-settled indicated that the pigment settled at a reduced rate and hence the pigment dispersion is more stable.

As shown in Table 3 below, the rates of settling of pigment were reduced when the pigment was coated by sufficient cross-linked and swollen polymers. Introduction of more polymers to the pigment surface and lightly cross-linking of these polymers produced stable pigment dispersions after the polymers were swollen. These tests used methyl ethyl ketone as the solvent for inversion and causing the swelling of the polymer. The Control Dispersion 1 was tested using water without any inversion.

TABLE 3

| Pigment | Starting | | | % Non-settled |
|---|---|---|---|---|
| Dispersion No. | Dispersion No. | P/M | % Crosslinker | (after 3 days) |
| 12 | 2 | 4 | 4 | 1.9 |
| 13 | 3 | 2 | 8 | 11.7 |
| 14 | 4 | 2 | 4 | 12.0 |
| 15 | 5 | 2 | 2 | 11.8 |
| 16 | 6 | 2 | 1 | 55.2 |
| 17 | 7 | 2 | 0.5 | 60.5 |
| 18 | 8 | 2 | 0.25 | 71.1 |
| 19 | 9 | 1 | 4 | 59.3 |
| 20 | 10 | 1 | 1 | 87.6 |
| 21 | 11 | 1 | 0.5 | 88.5 |
| Control | | 0 | 0 | 12.0 |
| Dispersion 1 | | | | |

To prove that the swelling of the polymer took place, the particles sizes of the dispersions were measured first in water, the initial solvent where the dispersion was made, and then in methyl ethyl ketone, a solvent that the dispersion was inverted into. The differences in particle sizes correlated to the degree of swelling of the particle. The results in Table 4 showed that as more polymer was introduced onto the pigment and lower levels of crosslinkers were used, a significant amount of swelling was obtained.

TABLE 4

| Pigment | Starting | | % | Particle size | Particle size |
|---|---|---|---|---|---|
| Disper- | Disper- | | Cross- | (D-50, nm, | (D-50, nm, |
| sion No. | sion No. | P/M | linker | in water) | in MEK) |
| 13 | 3 | 2 | 8 | 309 | 401 |
| 14 | 4 | 2 | 4 | 330 | 388 |
| 15 | 5 | 2 | 2 | 356 | 381 |
| 16 | 6 | 2 | 1 | 362 | 534 |
| 17 | 7 | 2 | 0.5 | 323 | 613 |
| 18 | 8 | 2 | 0.25 | 345 | 795 |
| 19 | 9 | 1 | 4 | 419 | 502 |
| 20 | 10 | 1 | 1 | 415 | 633 |
| 21 | 11 | 1 | 0.5 | 417 | 616 |
| Control | | 0 | 0 | 252 | flocculated |
| Pigment | | | | | |
| Disper- | | | | | |
| sion 1 | | | | | |

### Control Pigment Dispersion 2

The following describes the formulation of a pigment dispersion that had the cross-linked polymer added separately from the pigment dispersion.

Pigment Dispersion 1 (457.16 g) and Control Polymer 1 (1142.84 g) were blended together to give Control Pigment Dispersion 2 having a ratio of pigment to polymer of 1 with the polymer containing 4% of a crosslinker. The polymer is present in the dispersion, but not encapsulating the pigment. Settling tests were conducted using water as the solvent.

As shown in Table 5 below, Control Pigment Dispersion 2, with a polymer present, but not encapsulating the pigment, does not provide good, non-settling results. The inventive Dispersion 9, having polymer surrounding the pigment, provided much improved non-settling property. This comparison was done using the same ratio of pigment to polymer and same level of crosslinker, with the only difference being the polymer was added to the pigment dispersion in the control dispersion whereas in Dispersion 9, the pigment was surrounded by polymer.

TABLE 5

| | | | % | % Non- | % Non- |
|---|---|---|---|---|---|
| | | | Cross- | settled | settled |
| Sample | Description | P/M | linker | (after 3 days) | (after 7 days) |
| Pigment | Polymer | 1 | 4 | 70.1 | 22.5 |
| Disper- | around the | | | | |
| sion 9 | pigment | | | | |
| Control | Polymer | 1 | 4 | 11.9 | 0.0 |
| Pigment | added separate | | | | |
| Disper- | from the | | | | |
| sion 2 | pigment | | | | |

### Control Pigment Dispersion 3

This shows the preparation of a white pigment dispersion containing 20% of white pigment surrounded by a polymer from polymerization of monomers around the pigment without the presence of any crosslinker. The ratio of pigment to monomer is 2 to 1, which gave a pigment dispersion that contained 10% of a polymer from polymerization of monomers containing no crosslinkers.

To a 500 milliliter beaker were added Pigment Dispersion 1 (114.29 g) and Polymer Dispersant 1 (53.33 g), water (188.77 g), and butyl methacrylate (20.0 g). The resulting mixture was sonicated at 30% Amplitude using an intermittent sonication process of sonicating for 2 seconds followed by idling for 4 seconds for a total of 15 minutes. The sonicated mixture was then added to a 500 milliliter flask equipped with a thermometer, a stirrer, additional funnels, a heating mantle, a reflux condenser and a means of maintaining a nitrogen blanket over the reaction mixture. The contents in the flask were heated, to 72° C. To the flask was added in one shot a solution of Vazo® 52 (0.56 g) and aqueous potassium hydroxide (10% solution, 2.25 g) in water (80 g). The resulting mixture was maintained at 72° C. for three hours to give Control Pigment Dispersion 3 containing 20% of pigment and 10% of polymer (a Pigment/polymer ratio of 2/1) with the polymer having no crosslinker.

### Control Pigment Dispersion 4

A 500 gram sample of the Control Pigment Dispersion 3 was subjected, to a drying operation until the content of solids was greater than 98%. The sample was then added into MEK (400 g) to make a solvent based dispersion with 20% of solids.

Once this sample was added to MEK, the dispersion flocculated. It is thought that the polymer from the polymerization of butyl methacrylate around, the pigment surface might have dissolved after being placed, in the MEK solvent and consequently fell off the pigment surface. Thus the pigment was left with no means of stabilization in the solvent, as was also the case with Control Pigment Dispersion 1 (see results in Table 4).

### Pigment Dispersion 22

A high speed disperser (HSD) was charged with Polymer Dispersant 3 (2,334 g) and water (960 g). Mixing was conducted at slow speed for 15 minutes. Titanium dioxide pigment (RDIS from Kimera Chemicals, 7,000 g) was slowly added. The speed, of the HSD was increased to 3,000 rpm and mixing was continued for 1 hour. This provided a 68% pigment pre-mix. The pre-mix was then let down with water to give a 60% TiO2 pre-dispersion. The pre-dispersion was then passed twice through a media mill. Addition of Proxel GXL (Arch Chemicals, 20 g) gave a white TiO₂ dispersion, Pigment Dispersion 22, with 61.1% of pigment solids at a pH of 3.0.

### Pigment Dispersion 23

This shows the preparation of a white pigment dispersion containing 20% of a white pigment with polymer formed from the polymerization of monomers around the pigment.

To a 500 milliliter beaker were added Pigment Dispersion 22 (81.78 g), water (142.41 g), followed by a mixture containing butyl methacrylate (17.5 g), ethyleneglycol dimethacrylate (0.13 g) and Methacrylic acid (7.5 g), and lastly Vazo® 67 (0.56 g). The resulting mixture was sonicated at 30% Amplitude using an intermittent sonication process of sonicating for 2 seconds followed by idling for 4 seconds for a total of 15 minutes. The sonicated mixture was then added to a 500 milliliter flask equipped with a thermometer, a stirrer, additional funnels, a heating mantle, a reflux condenser and a means of maintaining a nitrogen blanket over the reaction mixture. The contents in the flask were heated to 72° C. The resulting mixture was maintained at 72° C. for three hours to give Pigment Dispersion 23 containing 20% of pigment and 10% of polymer (a Pigment/polymer ratio of 2/1) encapsulating the pigment with the polymer containing 0.5% of crosslinkers.

### Pigment Dispersion 24

This shows the preparation of a swollen, aqueous white pigment dispersion containing 5% of a white pigment.

Pigment Dispersion 23 (50.0 g) was mixed with water (150.0 g), and the pH of the mixture was adjusted, to 8.0 using aqueous potassium hydroxide to provide Pigment Dispersion 24.

Table 6 showed results from settling test obtained for Pigment Dispersions 23 and 24. These two pigment dispersions have the same compositions with the only difference being the pH. Dispersion 23 has a pH of 3. At this pH, the methacrylic acid containing polymer around the pigment did not swell, and therefore the pigment in this dispersion slowly settled. Dispersion 24 has a pH of 8.0, where the methacrylic acid containing polymer around the pigment swelled. The rate of settling for pigment in Pigment Dispersion 24 was significantly reduced.

TABLE 6

| | | | % | % Non- | % Non- |
|---|---|---|---|---|---|
| | | | Cross- | settled | settled |
| Sample | Description | P/M | linker | (after 3 days) | (after 7 days) |
| Pigment | Non-swollen, | 2 | 0.5 | 13.0 | 4.2 |
| Disper- | aqueous | | | | |
| sion 23 | dispersion at | | | | |
| | a pH of 3.0 | | | | |
| Pigment | Swollen, | 2 | 0.5 | 48.3 | 25.4 |
| Disper- | aqueous | | | | |
| sion 24 | dispersion at | | | | |
| | a pH of 8.0 | | | | |

### Pre-Polymerized Polymer 1

To a 12-liter flask equipped with a thermometer, a stirrer, additional funnels, a heating mantle, a reflux condenser and a means of maintaining a nitrogen blanket over the reactants are charged methacrylic acid (110.0 g), butyl methacrylate (440.0 g), isopropanol (640.0 g) and acetone (1,040.0 g). The mixture is heated to reflux temperature. To the mixture is added a solution (Feed I) containing methacrylic acid (220.0 g) and butyl methacrylate (880.0 g) over a period of 210 minutes. At the same time when Feed I is started, another solution (Feed II) containing Vazo® 52 (12.0 g) in acetone (172.0 g) is added over a period, of 300 minutes. Heating is maintained at reflux temperature for an additional 60 minutes (a total of 360 minutes) to give a polymer with a composition of 80/20 butyl methacrylate/methacrylic acid having 47.0% of solids.

The polymer is subjected to a drying operation followed by re-dissolving in MEK to give Pre-polymerized Polymer 1 with 45% of solids.

### Dispersion 25

The following shows how to prepare a pigment dispersion that has pre-polymerized polymer on it, and that the pre-polymerized polymer is crosslinked. This dispersion swells in an appropriate solvent and the pigment settles less than in a dispersion that does not contain the swollen polymer.

To a 2-liter flask equipped with a thermometer, a stirrer, additional funnels, a heating mantle, a reflux condenser and a means of maintaining a nitrogen blanket over the reactants are added Pigment Dispersion 22 (344.0 g), Pre-polymerized Polymer 1 (233.0 g), methyl ethyl ketone (50.0 g) and water (390.0 g). The resulting mixture is heated and maintain at reflux temperature for 2 hours. Removal of 178.0 g of solvent via a distillation provides a pigment dispersion with 25.0% of white pigment and 12.5% of pre-polymerized polymer on the pigment surface. To the pigment dispersion is added Denacol 32.1 (10.25 g) to effect the crosslinking of 30% of the acid groups that are present, leaving 70% of the acid groups uncrosslinked. The resulting pigment dispersion is then diluted with water to having 5% of pigment solids, and potassium hydroxide is added, to adjust the pH to 8.0.

This dispersion settles less than dispersions that don't have the swollen polymers on the pigment surface.

What is claimed is:

1. A pigment dispersion comprising: a dispersant, and a polymer-coated pigment comprising a polymer and a pigment particle in a dispersion medium, wherein the ratio of said pigment particle to said polymer is between 10:1 and 1:10; wherein said polymer is cross-linked with a crosslinker and said polymer swells in an application medium that utilizes said pigment dispersion; and wherein said dispersion medium and said application medium independently contain water, solvent, or mixtures thereof.

2. The pigment dispersion of claim 1, wherein said polymer-coated pigment has an average particle diameter of at least 200 nm.

3. The pigment dispersion of claim 2, wherein said polymer swell at least 10 nm in the application medium.

4. The pigment dispersion of claim 3, wherein the density of the pigment particle is greater than 2.0 g cm⁻³.

5. The pigment dispersion of claim 3, wherein said polymer is a pre-formed polymer.

6. The pigment dispersion of claim 3, wherein said polymer is formed, by polymerization of one or more monomers adsorbed onto the surface of said pigment particle.

7. The pigment dispersion of claim 3, wherein the ratio of said pigment particle to said polymer is between 5:1 and 1:10.

8. The pigment dispersion of claim 7, wherein the ratio of said pigment particle to said polymer is between 2:1 and 1:10.

9. The pigment dispersion of claim 3, wherein the dispersant is an acrylic resin.

10. The pigment dispersion of claim 3, wherein the dispersant is a graft polymer.

11. The pigment dispersion of claim 6, wherein the polymer is formed by polymerization of one or more monomers selected from the group consisting of acrylates, methacrylates, vinyl ethers, styrenes and maleic anhydrides.

12. The pigment dispersion of claim 6, wherein the polymer is formed by the polymerization of one or more monomers containing crosslinkers selected, from the group consisting of ethyleneglycol dimethacrylate, diethyleneglycol dimethacrylate, triethyleneglycol dimethacrylate, tetraethyleneglycol dimethacrylate, polyethyleneglycol dimethacrylate, ethyleneglycol diacrylate, diethyleneglycol diacrylate, triethyleneglycol diacrylate, tetraethyleneglycol diacrylate, polyethyleneglycol diacrylate, trimethylol propane trimethacrylate, trimethylol propane triacrylate, divinylbenzene, propyleneglycol dimethacrylate, dipropyleneglycol dimethacrylate, propyleneglycol diacrylate and dipropyleneglycol diacrylate.

13. The pigment dispersion of claim 6, wherein said pigment particle comprises titanium dioxide.

14. The pigment dispersion of claim 6, wherein said pigment particle comprises a magnetic component.

15. The pigment dispersion of claim 12, wherein the dispersion medium is water.

16. The pigment dispersion of claim 15, wherein the application medium is solvent.

17. The pigment dispersion of claim 12, wherein the dispersion medium is water with a pH of greater than 8.

18. The pigment dispersion of claim 17, wherein the application medium is water with a difference of greater than 3 in pH compared to the pH of the water in the dispersion medium.

19. The pigment dispersion of claim 12, wherein the dispersion medium is water with a pH of less than 6.

20. The pigment dispersion of claim 19, wherein the application medium is water with a difference of greater than 3 in pH compared to the pH of the water in the dispersion medium.

21. A paint comprising a pigment dispersion comprising: a dispersant, and a polymer-coated pigment comprising a polymer and a pigment particle in a dispersion medium, wherein the ratio of said pigment particle to said polymer is between 10:1 and 1:10; wherein said, polymer is cross-linked with a crosslinker and said polymer swells in an application medium that utilizes said pigment dispersion; and wherein said dispersion medium and said application medium independently contain water, solvent, or mixtures thereof.
